(19) United States
(12) Patent Application Publication
(10) Pub. No.: US 2021/0083238 A1
(43) Pub. Date: Mar. 18, 2021

(54) Housing for a Replaceable Stored Energy Source with a Connection Option for Supplying Power to an Electronic Device That Can Be Connected Thereto, and Wireless Hazard Detector

(71) Applicant: Siemens Schweiz AG, Zürich (CH)

(72) Inventor: Hilmar Konrad, Baar (CH)

(73) Assignee: Siemens Schweiz AG, Zürich (CH)

(21) Appl. No.: 16/618,848

(22) PCT Filed: May 11, 2018
(86) PCT No.: PCT/EP2018/062218

§ 371 Date: Dec. 3, 2019

(30) Foreign Application Priority Data
Jun. 13, 2017 (EP) 17175620.8

(51) Int. Cl. H01M 2/10; G08B 17/113

(52) U.S. Cl. CPC H01M 2/1055; G08B 17/113

(57) ABSTRACT

Various embodiments include a housing comprising: a shaped receiving compartment for receiving a stored energy source in the housing interior; a connection option for supplying power to an electronic device connected to the stored energy source; a main body; and a closure part movably attached to the main body. The main body is configured to be removably mounted on a mounting surface. When the main body is mounted and open, there is an access opening to the receiving compartment to allow removal of the stored energy source and insertion of a replacement. The housing includes a retaining device for removably attaching the stored energy source to the retaining device. The retaining device is configured so the stored energy source can be removed from the retaining device in a direction away from the mounting surface and can be attached to the retaining device in a counter-direction towards the mounting surface.

### CROSS-REFERENCE TO RELATED APPLICATIONS

This application is a U.S. National Stage Application of International Application No. PCT/EP2018/062218 filed May 11, 2018, which designates the United States of America, and claims priority to EP Application No. 17175620.8 filed Jun. 13, 2017, the contents of which are hereby incorporated by reference in their entirety.

### TECHNICAL FIELD

The present disclosure relates to stored energy sources. Various embodiments may include housings with a shaped receiving compartment for the installation of a stored energy source in the housing interior, wherein said housing has a connection option for supplying power to an electronic device that can be connected thereto. The housing has a main body which is designed to be mounted, in particular removably mounted, on a mounting surface. The mounting surface is typically a ceiling in a room of a building or in a hall. The mounting surface can alternatively be a wall.

### BACKGROUND

Existing position signaling transmitters (so-called “indoor positioning beacons”) such as e.g. the iBeacon from Apple Inc. have a battery (primary cell) for supplying power. The battery must be replaced every one to two years depending on the data traffic and the battery capacity. Such position signaling transmitters are typically mounted on the ceiling of a building. They are usually based on the Bluetooth Low Energy standard (BT LE).

The US patent application US 2016/0338212 A1 describes a battery compartment with a closable cover for a hazard detector. In its open state, the battery compartment allows simple access for manual replacement of the batteries. The six batteries shown can be levered out in succession by a user and then replaced via the battery compartment opening. For use as per specifications, the hazard detector can be secured to a mounting socket in a removable manner. The mounting socket is itself permanently attached to the ceiling. In the mounted state of the hazard detector, the battery compartment is not accessible.

The US patent application US 2012/0314344 A1 describes a battery compartment which can be obliquely pivoted out at the front side of the hazard detector. The battery compartment allows the battery (E-Block) to be replaced even when the hazard detector is mounted on the ceiling as per specifications. Two retaining flanges are arranged in the battery compartment in order to prevent the battery from falling out after the battery compartment is opened. In order to allow the battery to be replaced, it must be manually pushed into the battery compartment and then levered out past the two retaining flanges.

The UK patent application GB 2 263 810 A describes a battery compartment for a smoke detector, which battery compartment can be closed by a pivotable flap that is laterally attached to the main body of the smoke detector. In order to allow closure with the battery compartment, a snap-in element is formed at the free end of the flap. At the same time, the flap is screwed to the ceiling, such that the main body can pivot away from the flap in order to allow manual replacement of the battery. Therefore the smoke detector cannot be removed from the ceiling for the purpose of changing the battery.

The international publication WO 2016/020116 A1 describes a detector socket for securing to a mounting surface. Said detector socket has an electrical connection terminal for connection to a detector line of a hazard detector system and a first connection side for removably attaching a hazard detector. The first connection side is electrically and structurally compatible with a second connection side of such a hazard detector, such that this can be removably attached to the detector socket and can be connected to the detector line via said detector socket. The detector socket has a wireless device as an electronic module which is installed in the detector socket for transmitting position data of the mounting location of the detector socket and/or a reference thereto. The wireless device is fed via the detector line in this case. The power supply of the hazard detector and of the wireless device can also be buffered by a capacitor, accumulator or by a battery.

The power supply to the wireless device via the detector line is however subject to approval. An approval is protracted and expensive. It is therefore more favorable to supply the wireless device exclusively via a dedicated battery. Here too, the battery must nonetheless be regularly replaced as in the case of the prior art cited in the introduction. Hazard detectors such as e.g. fire alarms can be tested by means of a so-called exchanger and tester and removed from the detector socket and replaced if applicable. However, an administrative hazard detector control center or fire alarm control center must be switched off or switched into a service mode for this purpose, and a service technician made available, since a corresponding message is output from the fire alarm to the fire alarm control center if a fire alarm is removed from the detector socket. Replacement of the battery in the detector socket or generally in a housing on the ceiling is therefore resource-intensive and associated with the deployment of additional personnel.

### SUMMARY

The teachings of the present disclosure include a housing in which a stored energy source that is installed in the housing for the purpose of supplying power to an electronic device can be replaced in a particularly simple manner, in particular from the ground beneath the housing by personnel at a distance therefrom. Some examples include a housing comprising a connection base and a hazard detector which is removably attached thereto, wherein a stored energy source, in particular a battery, for supplying power to the hazard detector can be replaced in a simple manner during live operation of the hazard detector system.

As another example, some embodiments include a wireless hazard detector in which a stored energy source for supplying power to the hazard detector can be replaced in a simple manner during live operation.

Some embodiments include a housing which has a shaped receiving compartment (AR) for receiving a stored energy source (4) in the housing interior, wherein said housing (1) has a connection option (5, BL) for supplying power to an electronic device (6, 9, MK) that can be connected to the stored energy source (4), wherein the housing (1) comprises a main body (21) and a closure part (22, 26) which is movably attached thereto, wherein the main body (21) is designed in particular to be removably mounted on a mounting surface (MF), in particular a ceiling, wherein the closure part (22, 26) is provided in order to close the receiving compartment and is designed such that, when the main body (21) is mounted on the mounting surface (MF) and said closure part (22, 26) is open, it exposes an access opening (OP) to the receiving compartment (AR) in order to allow the removal of the stored energy source (4) and the insertion of a replacement stored energy source (4) via the access opening (OP), wherein the housing (1) has a retaining device (H) for removably attaching the stored energy source (4) to the retaining device (H), and wherein the retaining device (H) is designed such that the stored energy source (4) can be removed from the retaining device (H) in a direction (R1) away from the mounting surface (MF) and can be attached to the retaining device (H) in a counter-direction (R2) towards the mounting surface (MF).

In some embodiments, the closure part (22) which is movably attached relative to the main body (21) is connected to the main body (21) via a joint (20) such that the closure part (22) can be pivoted about a pivoting axis (D) of the joint (20), said axis (D) running parallel to the mounting surface (MF), in order to expose the access opening (OP) to the receiving compartment (AR).

In some embodiments, the closure part (22) which is movably attached relative to the main body (21) is connected to the main body (21) via a joint (20) such that the closure part (22) can be pivoted about a pivoting axis (D) of the joint (20), said axis (D) running perpendicular to the mounting surface (MF), in order to expose the access opening (OP) to the receiving compartment (AR).

In some embodiments, the closure part (22) which is movably attached relative to the main body (21) of the housing (1) is a sliding tray (26) which is arranged in the main body (21) and can be displaced parallel to the mounting surface (MF), wherein the sliding tray (26) comprises a sliding plate (27) with a front part (28), wherein the front part (28) closes the main body (21) when the sliding tray (26) is pushed in and wherein the front part (28) exposes the access opening (OP) to the receiving compartment (AR) when the sliding tray (26) is pulled out, wherein the sliding plate (27) comprises the retaining device (H), wherein the retaining device (H) is configured to allow the removable attachment of the stored energy source (4) when the sliding tray (26) is pulled out, and wherein the structural height of the sliding tray (26) is dimensioned such that the replacement stored energy source (4) which is attached to the sliding plate (27) can be pushed into the main body (21) of the housing (1).

In some embodiments, a wireless module, in particular a position signaling transmitter, is permanently installed as an electronic device (6) in the housing interior, and wherein the wireless module (6) is connected to the stored energy source (4) via a connection/contacting element (5) as a connection option for the purpose of supplying power when the removably attachable stored energy source (4) is installed, or the electronic device (6) is a wireless module, in particular a position signaling transmitter, and wherein the wireless module (6) together with the stored energy source (4) that is provided for supplying power to the wireless module (6) forms a structural unit (3) for removably attaching to the retaining device (H) as a connection option of the housing (1).

In some embodiments, the main body (21) at its end opposite the mounting surface (MF) forms a connection base (AB) as a connection option (5, BL) for supplying power to the electronic device (9) and for the in particular removable attachment of the electronic device (9) to the connection base (AB), and wherein the connection base (AB) is an integral part of the main body (21) or of the closure part (22) which is movably attached to the main body (21).

In some embodiments, the electronic device (9) is a hazard detector, in particular a smoke detector, an optical and/or acoustic alarm device or a motion detector.

In some embodiments, the connection base (AB) comprises an activating means (25), wherein the activating means (25) is so embodied as to activate a monitoring contact (SU) of a hazard detector (9) that is removably installed on the connection base (AB) only if said hazard detector (9) is installed in a final position that is prescribed for the correct operation of the hazard detector (9).

In some embodiments, the housing (1) has an electrical connection terminal (KL) for connection to an external line, in particular a detector line (ML), wherein the connection base (AB) comprises first electrical contacts (K1) which are connected via a connection line (L) that is arranged in the housing (1) and is in particular flexible to the electrical connection terminal (KL), wherein the first electrical contacts (K1) are so arranged as to contact with first electrical mating contacts (G1) of an electronic device (9) which is installed on the connection base (AB), in particular first electrical mating contacts (G1) of a removably installed hazard detector (9).

In some embodiments, the connection base (AB) that is formed in the main body (21) has first electrical contacts (K1) which are so arranged as to contact with first electrical mating contacts (G1) of a hazard detector (9) that is removably installed on the connection base (AB), wherein the main body (21) is designed for the housing (1) to be removably mounted on a detector socket (8) as a mounting surface (MF), wherein the detector socket (8) is designed to be secured to a ceiling in particular and is intended to be connected to a detector line (ML) and comprises second electrical contacts (K2), and wherein the main body (21) comprises second electrical mating contacts (G2) which are so arranged as to contact with the second electrical contacts (K2) after the housing (1) has been removably mounted on the detector socket (8).

In some embodiments, the closure part (22, 26) comprises a movable locking bar (71) which interacts mechanically with a fixed counterpart (72) of the main body (21) in such a way that the closure part (22, 26) interlocks with the main body (21) when the receiving compartment (AR) is closed, or the main body (21) comprises a movable locking bar (71) which interacts mechanically with a fixed counterpart (72) of the closure part (22, 26) in such a way that the closure part (22, 26) interlocks with the main body (21) when the receiving compartment (AR) is closed.

In some embodiments, the closure part (22, 26) comprises an unlocking aperture (EO) which is embodied on the outside (AS) thereof in such a way that an unlocking tool (11) which is geometrically compatible therewith can be inserted into the unlocking aperture (EO), in particular in a direction (R2) towards the mounting surface (MF), in order to unlock the closure part (22, 26) and the interlocked main body (21) for the purpose of reopening the receiving compartment (AR).

In some embodiments, the closure part (22) which is movably attached relative to the main body (21) is connected to the main body (21) via a joint (20), such that the closure part (22) can be pivoted about a pivoting axis (D) of the joint (2), said pivoting axis (D) running perpendicular to the mounting surface, in order to expose the access opening (OP) to the receiving compartment (AR), and wherein the closure part (22) comprises an insertion aperture (SL) as a pivot bearing which is aligned with the pivoting axis (D) and is embodied on the outside (AS) of said closure part (22) in such a way that a pivoting-open tool (11) which is geometrically compatible therewith can be inserted into the insertion aperture (EO), in particular in a direction (R2) towards the mounting surface (MF).

In some embodiments, the main body (21) comprises a tangential limit stop (TA) against which the closure part (22) rests in the closed state of the receiving compartment (AR), and wherein the closure part (22) automatically interlocks with the main body (21) again when the tangential limit stop (TA) is reached and in particular after the unlocking tool (11) is removed.

As another example, some embodiments include a wireless hazard detector (IoT), comprising a housing (1) as described above, wherein the housing (1) is a detector housing of the wireless hazard detector (IoT), wherein the main body (21) of the detector housing is designed to be mounted, in particular removably mounted, on a mounting surface (MF), in particular a ceiling, wherein the closure part (22) which is movably attached relative to the main body (21) is a floor element of a detector head (MK) which is part of the wireless hazard detector (IoT) and at the same time the electronic device (MK) that can be connected to the stored energy source (4) for its power supply, and wherein the detector head (MK) is connected via a battery line (BL) to a connection/contacting element (5) in the main body (21), such that the detector head (MK) is electrically connected to the stored energy source (4) for supplying power after installation of the stored energy source (4) in the receiving compartment (AR) of the main body (21).

In some embodiments, an electrical buffer store (KO), in particular a capacitor, is arranged in the wireless hazard detector (IoT), in particular in the detector head (MK) of the wireless hazard detector (IoT), for electrical buffering of the power supply to the detector head (MK) during the replacement of the stored energy source (4).

As another example, some embodiments include a first tool for unlocking, pivoting open and closing a housing (1) as described above, wherein the first tool (11) has a rod (13) which is preferably telescopic, an unlocking and pivoting device (14) which is formed at a first rod end, and a handle region (GR) which is formed at an opposite, second rod end, wherein the unlocking and pivoting device (14) has a first and second end with first and second pegs (15, 16) formed thereon, wherein the two pegs (15, 16) are embodied at a distance from each other and in such a way that they can engage in both an unlocking aperture (EO) and an insertion aperture (SL) of a housing (1) that is installed on the mounting surface (MF), and wherein a device (17) is provided between the first and second rod ends for the purpose of applying torque to the rod (13) when the housing (1) is to be pivoted open or closed.

As another example, some embodiments include a second tool for removing a stored energy source (4) which is removably attached to a retaining device (H) and for inserting a replacement stored energy source (4) via an access opening (OP) of a housing (1) as described above, said housing (1) being installed on a mounting surface (MF) and being in an open state, or of a wireless hazard detector (IoT) as described above, said wireless hazard detector (IoT) being installed on a mounting surface (MF) and being in an open state, wherein the second tool (12) comprises a rod (13) which is preferably telescopic, a grabber (18) which is formed at a first rod end, and a handle region (GR) which is formed at an opposite, second rod end, wherein the grabber (18) is designed in particular to be selectively opened or closed.

### BRIEF DESCRIPTION OF THE DRAWINGS

The teachings of the present disclosure are further explained with reference to the example in the following figures, in which:

FIG. 1 shows an example in a side view of a housing which is attached to the ceiling, with a closure part that can be pivoted open for the purpose of replacing a stored energy source incorporating teachings of the present disclosure;

FIG. 2 shows the example according to FIG. 1 in the open state,

FIG. 3 shows the example according to FIG. 1 in a top view of the housing along the viewing direction III,

FIG. 4 shows a housing connected to a detector line, with a connection base that is partially pivoted open and has a hazard detector attached thereto, incorporating teachings of the present disclosure;

FIG. 5 shows a housing with a connection base which is partially pivoted open and has a wireless hazard detector attached thereto incorporating teachings of the present disclosure;

FIG. 6 shows a wireless hazard detector incorporating teachings of the present disclosure for mounting on a mounting plate, with a closure part which is partially pivoted open;

FIG. 7 shows a top view of an exemplary wireless hazard detector incorporating teachings of the present disclosure with a closure part which is pivoted almost completely open and which can be pivoted about a pivoting axis that runs perpendicular to the ceiling,

FIG. 8 shows a detector socket which is connected to the detector line, with a housing that is attached thereto and with a connection base which is partially pivoted open and has a hazard detector that is attached thereto,

FIG. 9 shows a housing with a sliding tray in accordance with the invention that can be pulled out for the purpose of installing a stored energy source which can removably attached there,

FIG. 10 shows a top view of a further example of a housing with a connection base incorporating teachings of the present disclosure which can be pivoted about a pivoting axis that runs perpendicular to the ceiling,

FIG. 11 shows an example of an interlocking and unlocking mechanism for a housing incorporating teachings of the present disclosure;

FIG. 12 shows an example of a first tool according to the invention for unlocking, pivoting open and closing a housing incorporating teachings of the present disclosure; and

FIG. 13 shows an example of a second tool according to the invention for removing and inserting a stored energy source which can be removably attached to a retaining device of a housing incorporating teachings of the present disclosure.

### DETAILED DESCRIPTION

In some embodiments, a housing comprises a main body and a closure part which is movably attached thereto. The main body is designed to be removably mounted on a mounting surface, in particular on a ceiling. The closure part is provided in order to close the receiving compartment and is designed such that, when the main body is mounted on the mounting surface and said closure part is open, it exposes an access opening to the receiving compartment in order to allow the removal of the stored energy source and the insertion of a replacement stored energy source via the access opening. The housing has a retaining device for removably attaching the stored energy source to the retaining device. The retaining device is designed such that the stored energy source can be removed from the retaining device in a direction away from the mounting surface and can be attached to the retaining device in a counter-direction towards the mounting surface.

In some embodiments, the stored energy source in the housing can be replaced in a particularly simple manner by means of a tool and at a distance of up to several meters from the housing. This is achieved by removing the stored energy source from the mounting surface, in particular in a direction away from the ceiling, and reattaching it in the counter-direction towards the ceiling.

In some embodiments, the housing is removably attached to a mounting plate as a mounting surface, e.g. by means of a bayonet lock or a magnet. The mounting plate is itself permanently attached to the ceiling or the wall as a mounting surface. The closure part for closing the receiving compartment may also be referred to as a housing cover. The housing can therefore be removably attached at least indirectly to the mounting surface. The stored energy source may be a battery (primary cell) or an accumulator (secondary cell).

In some embodiments, the connection option provided by the housing for the purpose of supplying power to an electronic device that can be connected thereto, may be e.g. an electrical connection line which connects the stored energy source to the electronic device. The connection option may also be a connection/contacting element that is arranged in the housing, e.g. in the form of a battery contact, which is contacted by the stored energy source after the stored energy source is inserted into the receiving compartment. E.g. the electrical connection line for supplying power to the electronic device can then be connected to the battery contact. In some embodiments, the electrical connection line may be connected to connection contacts on the outside of the housing which contact mating contacts of the electronic device.

The electronic device may be e.g. a sensor unit for capturing an environment variable in the region of the housing. The sensor unit may be e.g. a temperature sensor, a humidity sensor, a gas sensor, in particular a CO sensor or CO₂ sensor, an air pressure sensor or a brightness sensor. The captured sensor values can be stored in a non-volatile electronic memory of the sensor unit, e.g. an SD memory card, preferably in a cyclical manner. The stored sensor values can be read out subsequently by removing the housing or removing the sensor unit from the receiving compartment. In some embodiments, the electronic device may be an actuator, e.g. an LED for continuous light or flashing light, or a loudspeaker, bleeper or klaxon.

The electronic device may be e.g. a wireless module. This can be based on e.g. a WLAN, Bluetooth (BT LE), 6LoWPAN or GSM standard. The wireless module may be configured to wirelessly output the previously captured sensor values or position data, e.g. GPS data for an indoor positioning/navigation system in a building.

In some embodiments, the closure part which is movably attached relative to the main body is connected to the main body via a joint, such that the closure part can be pivoted about a pivoting axis of the joint, said axis running parallel to the mounting surface, in order to expose the access opening to the receiving compartment. Relative to the closed state of the receiving compartment, the closure part can be pivoted about an angle in the range from 0° to at least 70°, or to at least 90°. The maximum pivoting angle may be 180°±10°.

In some embodiments, the closure part which is movably attached relative to the main body is connected to the main body via a joint, such that the closure part can be pivoted about a pivoting axis of the joint, said axis running perpendicular to the mounting surface, in order to expose the access opening to the receiving compartment. Relative to the closed state of the receiving compartment, the closure part can be pivoted about an angle in the range from 0° to at least 90°, or to at least 180°. The pivoting axis of the joint may be arranged at the radial outer edge or in the radial outer region of the main body relative to the axis of symmetry A of the housing or of the main body. In comparison with the preceding embodiment variant, when pivoted open, the closure part does not “get in the way” or obstruct a user wishing to replace the stored energy source or the electronic device and the stored energy source connected thereto.

In some embodiments, the access opening to the receiving compartment is freely accessible when the closure part is pivoted open for replacement of the stored energy source or the electronic module, even when the housing or the main body is mounted on the ceiling.

In some embodiments, the closure part which is movably attached relative to the main body of the housing is a sliding tray which is arranged in the main body and can be displaced parallel to the mounting surface. The sliding tray comprises a sliding plate with a front part, wherein the front part closes the main body when the sliding tray is pushed in and wherein the front part exposes the access opening to the receiving compartment when the sliding tray is pulled out. The sliding plate comprises the retaining device, wherein the retaining device is configured to allow the removable attachment of the stored energy source when the sliding tray is pulled out. The structural height of the sliding tray is dimensioned such that the stored energy source which is attached to the sliding plate as a replacement can be pushed into the main body of the housing. In the case of this embodiment variant likewise, the access opening to the receiving compartment is freely accessible when the sliding tray is pulled out, even when the housing or the main body is mounted on the ceiling.

In some embodiments, a wireless module, in particular a position signaling transmitter, is permanently installed as an electronic device in the housing interior. In the installed state of the stored energy source, the wireless module is then connected to the stored energy source for the purpose of supplying power via a connection/contacting element as a connection option.

In some embodiments, the electronic device may be a wireless module, in particular a position signaling transmitter, which together with the stored energy source that is provided for supplying power to the wireless module forms a structural unit for removably attaching to the retaining device as a connection option of the housing.

In some embodiments, the main body forms a connection base at its end opposite the mounting surface, in the form of a detector socket, as a connection option for supplying power to the electronic device and for the attachment, in particular removable, of the electronic device to the connection base. The connection base is an integral part of the main body. Alternatively, the connection base may be the closure part which is movably attached to the main body.

The electronic device may comprise a hazard detector. This may be e.g. a smoke detector, an optical and/or acoustic alarm device or a motion detector. The electronic device may also be a comfort detector, e.g. for capturing the room temperature, the air humidity and/or the air quality, in particular the CO₂ content.

In some embodiments, the connection base comprises a mechanical activating means which is so embodied as to activate a monitoring contact of a hazard detector that is removably installed on the connection base only if said hazard detector is installed in a final position that is prescribed for the correct operation of the hazard detector.

In some embodiments, the housing comprises an electrical connection terminal for connecting the housing to a detector line. The connection base comprises first electrical contacts which are connected via a connection line, this being arranged in the housing and being in particular flexible, to the electrical connection terminal. The first electrical contacts are so arranged as to contact with first electrical mating contacts of an electronic device which is installed on the connection base, in particular first electrical mating contacts of a removably installed hazard detector.

In some embodiments, the hazard detector does not have to be removed from the housing in order to effect a change of battery. The hazard detector remains operationally deployed. An error message that would otherwise be output or generated by the hazard detector when the hazard detector is removed does not occur. There is no requirement here for additional personnel to switch the hazard detector system into test mode.

In some embodiments, the connection base that is formed in the main body comprises first electrical contacts which are so arranged as to contact with first electrical mating contacts of a hazard detector that is removably installed on the connection base. The main body is designed for the housing to be removably mounted on a detector socket as a mounting surface. The detector socket is designed to be secured to a ceiling in particular and is intended to be connected to a detector line and comprises second electrical contacts. The main body comprises second electrical mating contacts, which are so arranged as to contact with second electrical contacts after the housing has been removably attached to the connection socket.

In some embodiments, the housing can be attached subsequently, in the manner of a sandwich, as an intermediate base between an existing detector socket and a hazard detector which is already attached thereto. Following the insertion, the hazard detector continues to be operated on the detector line as before.

In some embodiments, the closure part comprises a movable locking bar which interacts mechanically with a fixed counterpart of the main body in such a way that the closure part interlocks with the main body when the receiving compartment is closed. In some embodiments, the main body comprises a movable locking bar which interacts mechanically with a fixed counterpart of the closure part in such a way that the closure part interlocks with the main body when the receiving compartment is closed.

In some embodiments, the closure part comprises an unlocking aperture which is embodied on the outside thereof in such a way that an unlocking tool which is geometrically compatible therewith can be inserted into the unlocking aperture, in particular in a direction towards the mounting surface, in order to unlock the closure part and the interlocked main body for the purpose of reopening the receiving compartment.

In some embodiments, the closure part which is movably attached relative to the main body is connected to the main body via a joint, such that the closure part can be pivoted about a rotational axis perpendicular to the mounting surface in order to expose the access opening to the receiving compartment. The closure part has an insertion aperture as a pivot bearing which is aligned with the rotational axis and is embodied on the outside of said closure part in such a way that a pivoting-open tool which is geometrically compatible therewith can be inserted into the insertion aperture, in particular in a direction towards the mounting surface.

In some embodiments, the main body comprises a tangential limit stop against which the closure part rests in the closed state of the receiving compartment. The closure part automatically interlocks with the main body again when the tangential limit stop is reached and in particular after the unlocking tool is removed.

Some embodiments include a wireless hazard detector. Such hazard detectors may be smoke detectors, optical and/or acoustic alarm devices or motion detectors. Such a hazard detector typically comprises a wireless module. The wireless module can be based on e.g. a WLAN, Bluetooth (BT LE), 6LoWPAN or GSM standard. The wireless module may be configured to forward captured sensor values and/or alarm messages and warning messages derived therefrom to an administrative control center, e.g. to a fire alarm control center, or to a proximate wireless hazard detector for onward routing to the administrative control center.

The wireless module may also be configured to forward the captured sensor values and/or the alarm messages and warning messages derived therefrom via a wireless internet connection to a cloud infrastructure in which a cloud application is executed. The latter may simulate the administrative control center in terms of its technical function. The standards cited above apply likewise for the wireless internet connection. Such wireless hazard detectors, which communicate at least indirectly with the cloud infrastructure, are also referred to as IoT hazard detectors. IoT here signifies “Internet of Things”.

In some embodiments, the housing is a detector housing of the wireless hazard detector. In some embodiments, the wireless hazard detector comprises a housing as described herein. The main body of the detector housing is designed to be mounted, in particular removably, on a mounting surface, in particular a ceiling. The mounting surface can itself be a mounting socket which is secured to the ceiling and to which the inventive hazard detector can then be secured, in particular removably. The closure part which is movably attached relative to the main body is now a floor element or a floor plate of a detector head. In this case, the detector head is part of the wireless hazard detector and at the same time the electronic device that can be connected to the stored energy source for its power supply. The detector head is connected via a battery line to a connection/contacting element in the main body, such that the detector head is electrically connected to the stored energy source for supplying power after installation of the stored energy source in the receiving compartment of the main body.

In some embodiments, a wireless hazard detector or wireless IoT hazard detector allows the detector housing thereof to be opened during live operation in order to change a battery that is running low. In some embodiments, an electrical buffer store for electrical buffering of the power supply of the detector head is arranged in the wireless hazard detector, in particular in the detector head of the wireless hazard detector, in order to ensure a continued power supply during replacement of the stored energy source. The electrical buffer store is e.g. a capacitor, e.g. an electrolyte capacitor, or an accumulator. The electrical capacity of the buffer store may be dimensioned such that replacement of the stored energy source within 30 min, or within 10 min, is assured without interruption of the power supply.

Some embodiments include a first tool for unlocking, pivoting open and closing a housing or wireless hazard detector according to the invention. In some embodiments, the first tool has a rod which may be telescopic, an unlocking and pivoting device which is formed at a first rod end and a handle region which is formed at an opposite, second rod end. The unlocking and pivoting device has a first and second end with first and second pegs formed thereon. The two pegs are embodied at a distance from each other and in such a way that they engage in both an unlocking aperture and an insertion aperture of a housing or wireless hazard detector that is installed on the mounting surface. A device is provided between the first and second rod ends for the purpose of applying torque to the rod when the housing or wireless hazard detector is to be pivoted open or closed.

The first tool provides a particularly simple means of unlocking the connection base from the main body and pivoting the connection base open, or unlocking the detector head from the main body and pivoting it open, in order to obtain access to the receiving compartment in the interior of the housing or detector housing for the purpose of changing a battery. Conversely, it is likewise easy for the connection base to be closed and automatically interlocked with the main body. In this case, the operation of a hazard detector attached to the connection base or of the detector head itself is not restricted in any way.

Some embodiments include a second tool with a particularly simple means of removing the exhausted stored energy device that is to be replaced, and inserting a new stored energy source into the housing or into the detector housing. In some embodiments, the second tool for removing a stored energy source removably attached to a retaining device, and for inserting a replacement stored energy source, via an access opening of a housing that is installed on a mounting surface and is in an open state or of a wireless hazard detector that is installed on a mounting surface and is in an open state. The second tool comprises a rod which may be telescopic, a grabber which is formed at a first rod end and a handle region which is formed at an opposite, second rod end. The grabber may be designed to be selectively opened or closed.

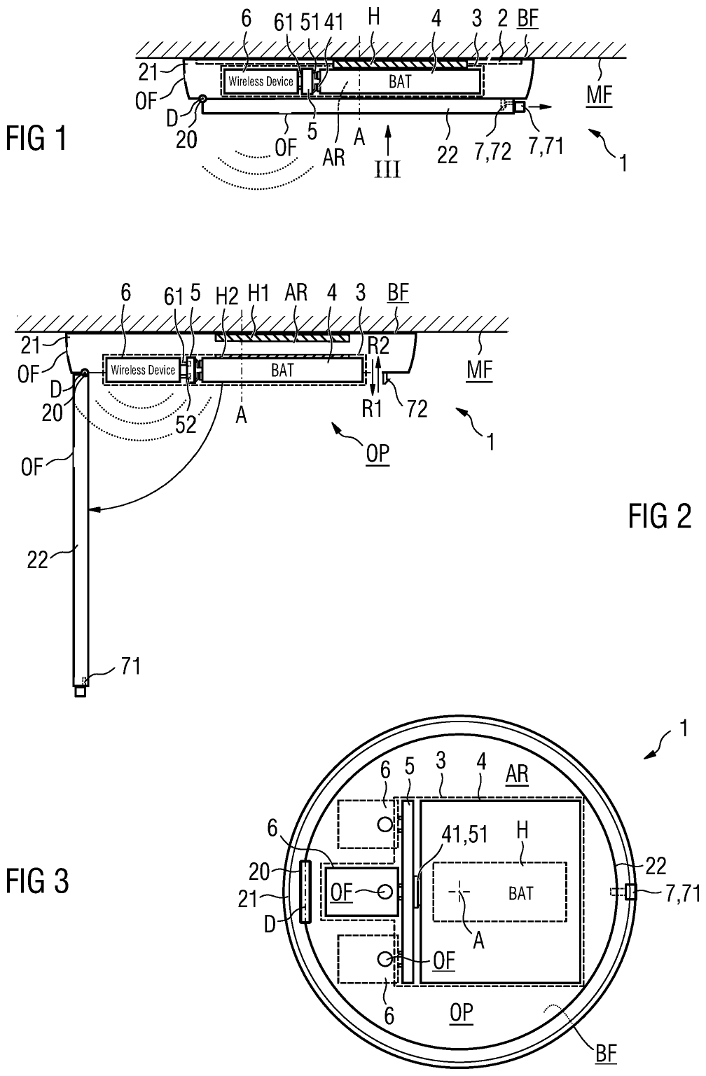

FIG. 1 shows an example of a housing 1 which is attached to the ceiling MF, with a closure part 22 that can be pivoted open for the purpose of replacing a stored energy source 4 in accordance with the invention. The housing 1 shown is removably attached to a mounting plate 2, which itself is permanently attached to the ceiling MF as a mounting surface. The reference sign 21 designates a main body and the reference sign 22 designates a closure part. BF designates a substantially plane securing surface of the main body 21, by means of which the main body 21 can be attached to the mounting surface MF. The securing surface BF can also be referred to as the securing side. The housing 1 shown is so designed as to be substantially rotationally symmetrical about an axis of symmetry A.

A receiving compartment AR for a battery 4 as a stored energy source and for a wireless module 6 (wireless device) as an electronic device is formed in the interior of the housing 1. The wireless module 6 can be configured to capture and wirelessly output an ambient temperature, a humidity value and/or a CO₂ concentration value as typical comfort variables in a building. For the purpose of capturing the comfort variables in the housing 1, inlet openings OF to the receiving compartment AR are provided in the closure part 22. The wireless module 6 can also be configured to wirelessly output position details for the mounting location of the housing 1 in the building. The position details may be GPS coordinates, relative coordinates to a reference point of the building or a pointer thereto, e.g. an internet link (URL) to an associated database.

The housing 1 shows a connection/contacting element 5 in the receiving compartment AR, comprising battery mating contacts 51 which allow contact with battery contacts 41 on the stored energy source 4 or on the battery. The connection/contacting element 5 also provides an electrical connection terminal 52 in the form of socket connectors, which contact with connection contacts 61 in the form of connection pins of the wireless module 6. The connection/contacting element 5 therefore functions as a plug-in socket for the electrical connection of a wireless module 6.

In some embodiments, connection/contacting element 5 may be permanently arranged in the receiving compartment AR. This means that a battery 4 can be inserted into the receiving compartment AR in the sense of a battery compartment, wherein the battery contacts 41 then contact with the battery mating contacts 51. As an alternative to contacting the battery 4 with the connection/contacting element 5 on one side and contacting the wireless module 6 with the connection/contacting element 5 on the other side, the battery 4 and the wireless module 6 can also form a combined structural unit 3 for insertion or replacement via the access opening OP. This means that the structural unit 3 forms an autonomous unit.

In some embodiments, the closure part 22 is provided for the purpose of closing the receiving compartment AR and is so designed as to expose an access opening OP to the receiving compartment AR when in the open state (see FIG. 2). In order to allow closure, the main body 21 and the closure part 22 are connected together via a hinge 20. As a joint, the hinge 20 allows (exclusively) pivoting movements about a pivoting axis D of the hinge 20. The latter is designed and aligned in such a way that the pivoting axis D runs parallel to the securing surface BF of the housing 1 and hence parallel to the opposing mounting surface MF. As a result of pivoting open the closure part 22 or housing cover, it is then possible to remove the stored energy source 4 and insert a replacement stored energy source 4 via the access opening OP.

In order to prevent the closure part 22 from accidentally opening or pivoting open, the closure part 22 comprises a movable or mobile locking bar 71 which mechanically interacts with a fixed counterpart 72 on the main body 21 in such a way that the closure part 22 interlocks with the main body 21 when the receiving compartment AR is closed. The locking bar 71 and the fixed counterpart 72 together form an interlocking mechanism 7.

FIG. 2 shows the example according to FIG. 1 in the open state. In some embodiments, the housing 1 comprises a retaining device H for removably attaching at least the battery 4 to the retaining device H. The latter is designed in such a way that the battery 4 alone or, as in the example shown in FIG. 2, with the wireless module 6, i.e. as a structural unit 3, can be removed from the retaining device H in a direction R1 away from the mounting surface MF. Conversely, the structural unit 3 shown or the battery 4 alone can be reattached to the retaining device H in a counter-direction R2 towards the mounting surface MF. An exhausted battery 4 or an exhausted accumulator 4 can thus be replaced by a new unit 4 of a similar construction or type. In some embodiments, an exhausted battery 4 can also be replaced by a charged accumulator 4, e.g. an Li-Ion accumulator or an NiMH accumulator with low spontaneous discharge, e.g. of the Eneloop type from Panasonic.

In some embodiments, the retaining device H comprises a part H1 on the housing and a part H2 on the stored energy source. The part H1 on the housing can be e.g. a permanent magnet, and the part H2 on the stored energy source can be a piece of soft magnetic sheet metal. The retaining device H can also be a two-part Velcro fastener. The removal of the battery 4 from the retaining device H can be effected manually or by means of a tool as shown by the example in FIG. 11. The present FIG. 2 also shows how the closure part 22 can be unlocked by means of sideways withdrawal of the locking bar 71 (see FIG. 1) and then pivoted open (see FIG. 2). The counterpart 72 to the locking bar 71 is attached to the main body 21 and is formed as a hook here by way of example.

FIG. 3 shows the example according to FIG. 1 in a top view of the housing 1 along the viewing direction III. In this illustration, the hinge 20 which allows the closure part 22 to pivot open is clearly visible. Also visible is the comparatively large battery 4, the battery contacts 41 thereof contact with battery mating contacts 51 of the connection/contacting element 5. If the latter is so designed as to be permanently attached to the housing, it can provide e.g. three plug-in sockets as shown. This means that a maximum of three sensor units, actuators or wireless modules 6, or a combination thereof as an electronic module, can be attached to the connection/contacting element 5 and each be supplied with electrical power thereby.

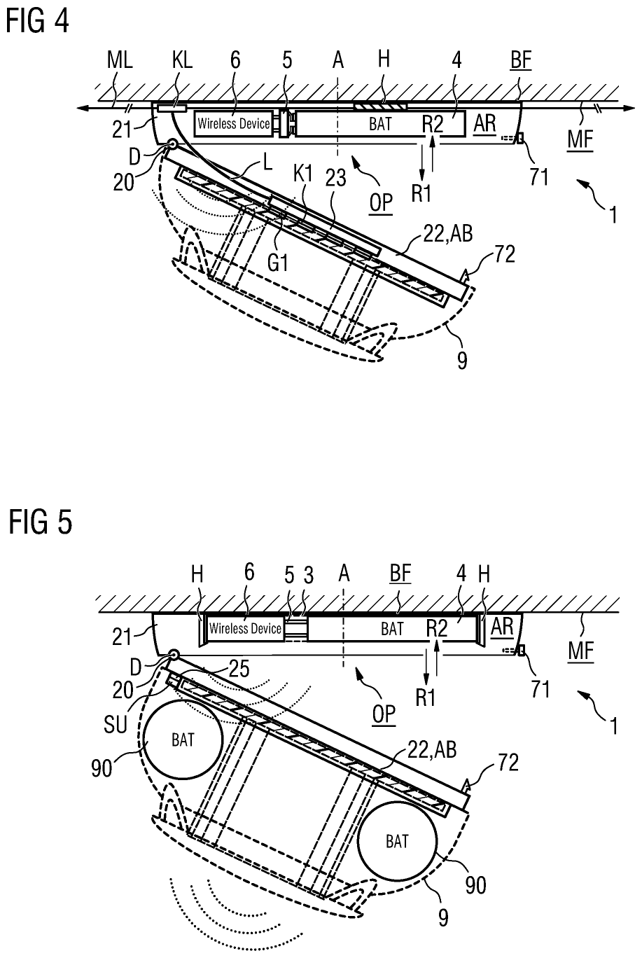

FIG. 4 shows a housing 1 connected to a detector line ML, with a connection base AB as a closure part 22 which is partially pivoted open and has a hazard detector 9 attached thereto. Unlike the previous exemplary embodiments, a connection terminal KL is provided in the housing 1 in order to connect the housing 1 in the form of a detector socket to a detector line ML of a hazard detector system. The connection base AB is designed to allow the removable installation of the hazard detector 9. On the side facing the hazard detector 9, it has first electrical contacts K1 which contact with first electrical mating contacts G1 of the hazard detector 9 after correct attachment to the connection base AB. The first electrical contacts K1 are arranged on a printed circuit board 23 in or on the connection base AB. The hazard detector 9 is then connected to the detector line ML via a flexible line L that is looped through. The connection base AB can therefore be pivoted open in order to change the battery without having to remove the hazard detector 9 and without a corresponding error message being generated by the hazard detector system as a result of the hazard detector 9 being removed from the connection base AB. The hazard detector 9 shown is e.g. a smoke detector.

FIG. 5 shows a housing 1 with a connection base AB which is partially pivoted open and has a wireless hazard detector 9 connected thereto. Unlike the preceding embodiment variant, the hazard detector 9 is connected at least indirectly via a wireless connection to an administrative hazard detector control center of a hazard detector system. For an autonomous power supply, this hazard detector 9 has dedicated batteries 90. The line-based detector line ML can therefore be omitted. In order to monitor the removal of the wireless hazard detector 9 from the connection base AB, the wireless hazard detector 9 has a monitoring contact SU.

In some embodiments, the monitoring contact SU is only activated by an activating means 25 on the connection base AB, which allows closing and opening, if the hazard detector 9 is installed in a final position on the connection base AB, said final position being prescribed for the correct operation of the hazard detector 9. The monitoring contact SU can be e.g. an electrical contact which is mechanically activated. In some embodiments, the monitoring contact SU can be a Hall sensor or a reed relay which is activated by a magnet on the connection base AB as an activating means 25. Otherwise, the wireless hazard detector 9 sends a corresponding error message to the hazard detector control center. The wireless hazard detector 9 shown is e.g. a wireless smoke detector. It can alternatively also be a wirelessly operated optical and/or acoustic alarm device, e.g. a flashing alarm light, a so-called sounder, or a motion detector. In the example as per FIG. 5, the retaining device H is realized by a snap-in element or catch element which is arranged in the receiving compartment AR and is shaped such that an installed battery 4 can be pulled out of the retaining device H with some expenditure of force and can be snapped in again in the reverse manner.

In some embodiments, the removable retaining device H and the connection/contacting element 5 can be embodied such that the stored energy source 4 which must be attached can be secured in the retaining device H by means of a rotary movement about an axis perpendicular to the mounting surface in the manner of a bayonet lock, and that the battery contacts 41 of the stored energy source 4 in the secured final rotated position of the stored energy source 4 in the retaining device H contact with the battery mating contacts 51 of the connection/contacting element 5.

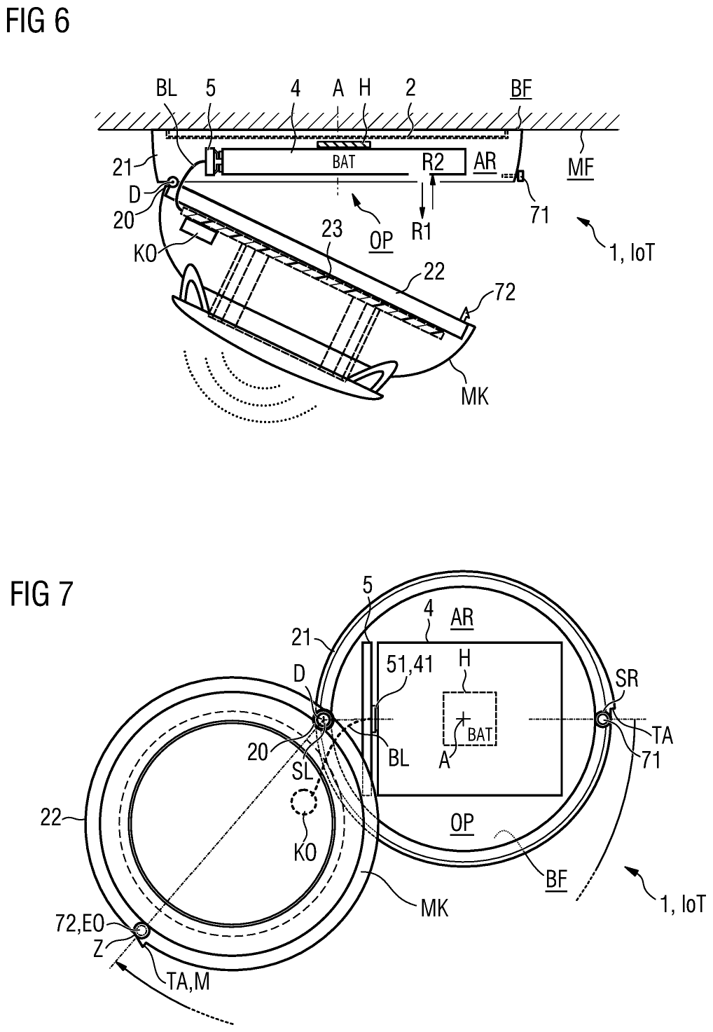

FIG. 6 shows a wireless hazard detector IoT incorporating teachings of the present disclosure for mounting on a mounting plate 2 and with a closure part 22 which is partially pivoted open about a pivoting axis D which runs parallel to the mounting surface MF or securing surface BF. The hazard detector IoT may be removably mounted on the mounting plate 2, the mounting plate 2 itself being attached to the mounting surface MF. In some embodiments, the wireless hazard detector IoT can also be designed to be mounted directly on the mounting surface MF. The mounting surface is typically the ceiling in a building. It can alternatively be a wall in a building.

The present FIG. 6 shows the wireless hazard detector IoT with a detector head MK which is partially pivoted open. In the fully open state, i.e. when pivoted open at an angle of approximately 90° or more, it is then possible to remove the stored energy source 4 in a direction R1 away from the mounting surface MF and to reattach a replacement stored energy source 4 in a counter-direction R2 towards the mounting surface MF. The stored energy source 4 to be removed and the replacement stored energy source 4 provided are preferably of the same structural type.

In some embodiments, the detector head MK is supplied with power from the stored energy source 4 via a battery line BL. The flexible battery line BL allows continued operation of the detector head MK irrespective of the angle at which it is pivoted open. In some embodiments, a capacitor KO is arranged on a circuit board 23 of the detector head MK as an electrical buffer store which provides the power supply for the detector head MK during the time the stored energy source 4 is being replaced.

FIG. 7 shows a top view of an exemplary wireless hazard detector IoT with a closure part 22 which is almost fully open and which can be pivoted about a pivoting axis D that runs perpendicular to the ceiling MF or to the securing surface BF. In order to allow the detector housing 1 or the detector head MK to pivot open from the main body 21, an insertion aperture SL in the form of a blind hole, this being aligned with the pivoting axis D, is provided in an associated joint 20 or hinge as a torque support. An uninterrupted unlocking aperture EO is provided at lever distance on the other end of the detector head MK, i.e. radially opposite the pivoting axis D, and likewise extends perpendicular to the ceiling MF or to the securing surface BF. Z designates a centric widening of the unlocking aperture EO, in order to facilitate the insertion of a corresponding tool. The unlocking mechanism 71, 72 for unlocking an interlocked connection base AB and for interlocking the same with the main body 21 again is itself explained in detail below with reference to FIG. 11.

The main body 21 also comprises a tangential limit stop TA against which the closure part 22 or the detector head MK rests (as defined) in the closed state of the receiving compartment AR. The closure part 22 which is movably attached relative to the main body 21 and which forms a floor element or floor plate of the detector head MK then automatically interlocks with the main body 21 again when the tangential limit stop TA is reached and in particular after a corresponding unlocking tool 11 is removed. The limit stop TA also serves as a colored marking M, for example.

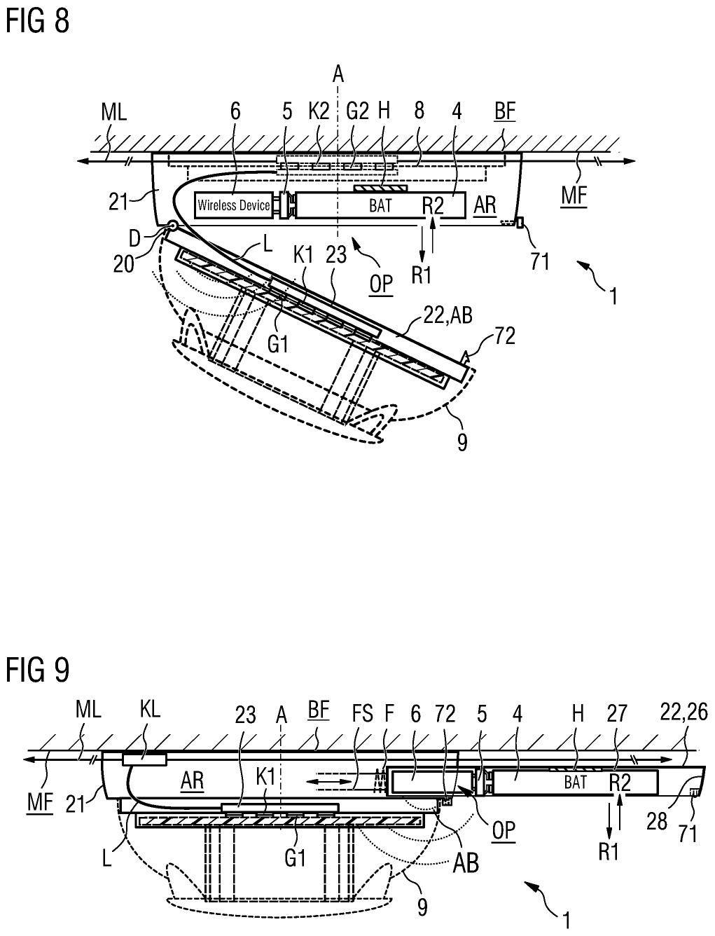

FIG. 8 shows a detector socket 2 which is connected to the detector line ML, with a housing 1 according to the invention that is attached thereto and with a connection base AB which is partially pivoted open and has a hazard detector 9 attached thereto. In comparison with FIG. 4, the main body 21 is designed for the housing 1 to be removably mounted on the detector socket 2 as a mounting surface MF. The detector socket 2 is designed to be secured to the ceiling and connected to the detector line ML. It comprises second electrical contacts K2 in this case. The main body 21 has second electrical mating contacts G2 which are so arranged as to contact with the second electrical contacts K2 after the housing 1 has been removably mounted on the detector socket 2.

The first and second electrical contacts K1, K2 and the first and second electrical mating contacts G1, G2 may be structurally and geometrically identical in particular. It is then possible as part of an upgrade to remove a hazard detector 9 that is already installed on a detector socket 2, and to removably attach said hazard detector 9 to the housing 1 again after the housing 1 has been removably mounted on the detector socket 2. In this case, the detector line ML is electrically connected via the second contacts K2, G2, onward via the flexible line L that is looped through, and finally via the first contacts K1, G1 to the installed hazard detector 9.

FIG. 9 shows a further housing 1 with a sliding tray 26 which can be pulled out as a closure part 22 that is so attached as to be movable relative to the main body 21 for the purpose of removably installing the stored energy source 4. The sliding tray 26 is arranged such that it can be displaced parallel to the mounting surface MF or the securing surface BF of the housing 1. The sliding tray 26 comprises a sliding plate 27 with a front part 28. The latter closes the main body 21 when the sliding tray 26 is pushed in. Conversely, the front part 28 exposes the access opening OP to the receiving compartment AR when the sliding tray 26 is pulled out. The sliding plate 27 also comprises a retaining device H which is configured to allow the removable attachment of the battery 4 when the sliding tray 26 is pulled out, again by means of e.g. a Velcro fastener. The structural height of the sliding tray 26 is dimensioned such that the replacement battery 4 which is attached to the sliding plate 27 can be pushed back into the main body 21 of the housing 1. The removal and attachment of the battery 4 from and to the retaining device H is again effected in a first direction R1 away from the mounting surface MF and in a counter-direction R2 towards the mounting surface MF.

The sliding tray 26 can be mounted in a displaceable manner by means of guide rails FS in the housing 1. F designates a spring element, e.g. a cylinder spring, which is pretensioned when the sliding tray 26 is pushed into the housing 1. The sliding tray 26 and the spring element F, together with an interlocking mechanism 71, 72 between sliding tray 26 and main body 21, are coordinated with each other in such a way that the sliding tray 26, when pushed in, is unlocked by means of lateral pressure on the front plate 28 in the manner of a push-push mechanism and is pushed out of the housing 1 by the pretensioned spring element F. After the battery has been changed, the sliding tray 26 can be pushed into the housing against the spring element F by means of lateral pressure again until the sliding tray 26 in its pushed-in state, and in particular when pushed slightly further, interlocks with the housing 1 again. The push-push principle is known from ball-point pens, for example.

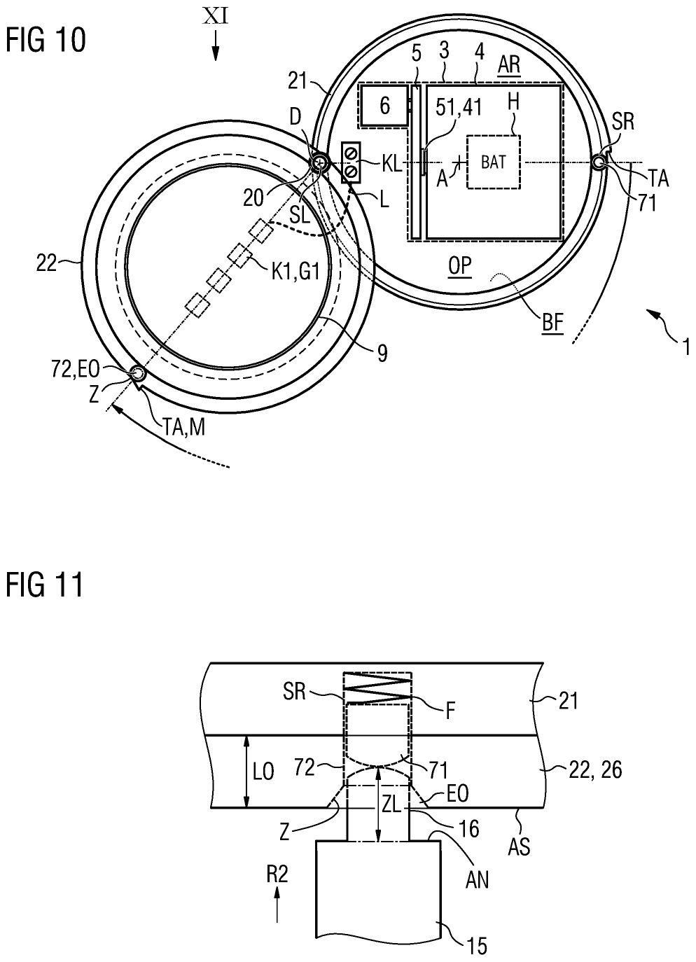

FIG. 10 shows a top view of a further example of a housing 1 with a connection base AB which can be pivoted in accordance with the invention about a pivoting axis D that runs perpendicular to the ceiling MF or securing surface BF. A hazard detector 9 is again attached to the connection base AB. In order to allow the connection base AB to pivot open, an insertion aperture SL in the form of a blind hole, this being aligned with the pivoting axis D, is provided in an associated joint 20 or hinge as a torque support. An uninterrupted unlocking aperture EO is provided at lever distance on the other side of the connection base AB, i.e. radially opposite the pivoting axis D, and likewise extends perpendicular to the ceiling MF or to the securing surface BF. Z again designates a centric widening of the unlocking aperture EO, in order to facilitate the insertion of a corresponding tool (see FIG. 11).

The main body 21 also comprises a tangential limit stop TA against which the closure part 22 or the connection base AB rests (as defined) in the closed state of the receiving compartment AR. The connection base AB then automatically interlocks with the main body 21 again when the tangential limit stop TA is reached and in particular after a corresponding unlocking tool 11 is removed. The limit stop TA also serves as a colored marking M, for example.

FIG. 11 shows an example of an interlocking and unlocking mechanism 71, 72 for a housing 1 according to the invention, by means of a first tool 11. The sectional view shown runs through the main body 21 and through the closure part 22 or the connection base AB, the receiving compartment AR being in a closed state. As shown in FIG. 11, the unlocking aperture EO and a blind hold SR for a locking bar 71 in the main body 21 are situated directly opposite each other when the connection base AB is in a closed state. This is achieved by means of the tangential limit stop TA described above. Inserted into the unlocking aperture EO is a further spring F, which rests against a floor of the unlocking aperture EO on one side and against a locking bar 71 in the form of a pin on the other side.

A first peg 15 of a first tool 11, whose peg length ZL corresponds to the length LO of the unlocking aperture EO, engages in the unlocking aperture EO. The first peg 15 comprises a limit stop AN for this purpose. When the first peg 15 is fully inserted into the unlocking aperture EO, the pin-shaped locking bar 71 is pushed against the further spring F2 into the blind hole SR of the locking bar. In this position, the locking bar 71 no longer projects into the closure part 22 or the receiving base AB and therefore no longer projects into the unlocking aperture EO as a fixed counterpart 72 to the locking bar 71. The closure part 22 can now be moved by means of the first peg 15 in the direction of the image plane shown and away from the tangential limit stop TA. The locking bar 72 and the further spring F2 may be prevented from falling out of the blind hole SR of the locking bar. The directly opposing ends of the first peg 15 and the locking bar 71 are preferably dome-shaped as shown, in order to allow the closure part 22 to interlock with the main body 21 again after a battery change, for example. If the first peg 15 is then withdrawn from the unlocking aperture EO in the closed state, the locking bar 71 snaps back into the unlocking aperture EO due to the spring pretension, thereby causing the main body 21 to interlock with the connection base AB or closure part 22.

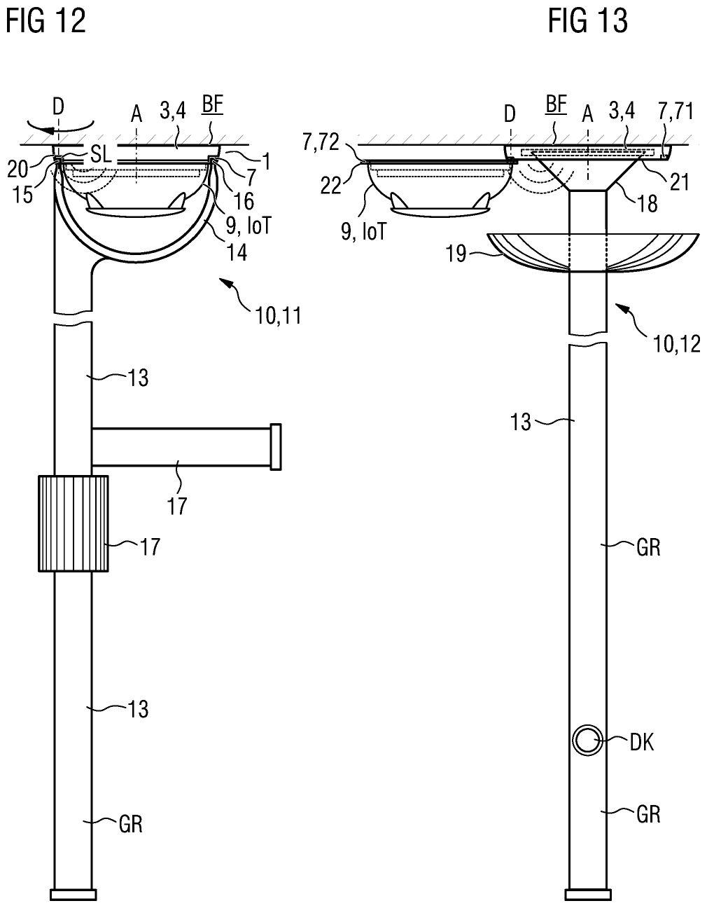

FIG. 12 shows an example of a first tool 11 for unlocking, pivoting open and closing a housing 1. The first tool 11 shown comprises a rod 13 which may be telescopic, an unlocking and pivoting device 14 which is formed at a first rod end and has the shape of a stirrup, and a handle region GR in the form of a grip which is formed at an opposite, second rod end. A first and second peg 15, 16 are provided on the unlocking and pivoting device 14 and may be shaped identically. The two pegs 15, 16 are embodied at a distance from each other and in such a way that they can engage in both an unlocking aperture EO and an insertion aperture SL of a housing 1 which is installed on the mounting surface MF. By virtue of the stirrup shape of the unlocking and pivoting device 14, an electronic device 9 which is attached to the housing 1, such as e.g. the smoke detector in this case, is so-to-speak “not in the way”. A device 17 for applying torque to the rod 13 is provided between the first and second rod ends so that the housing 1 can be pivoted open and closed. As shown in the example, the device 17 can be a grip or an arm which points away from the rod 13.

FIG. 13 shows an example of a second tool 12 for removing and for inserting a stored energy source 4 which is removably attached to a retaining device H of a housing 1, in the form of a so-called exchanger and tester. The second tool 12 likewise comprises a rod 13 which may be telescopic. It also comprises a grabber 18 which is formed at a first rod end and a handle region GR in the form of a grip which is formed at an opposite, second rod end. In this case, the grabber 18 can be designed to be selectively opened and closed. This can be realized e.g. by means of a push button DK which is formed in the handle region GR and which opens the grabber 18 via an active connection (mechanical or electrical) in order to release the stored energy source 4 after attachment of the stored energy source 4 to the retaining device H of the housing 1. Conversely, the grabber 18 can be triggered to close, i.e. grab, in order to grasp in a positive manner the stored energy source 4 that must be replaced, and to withdraw same from the retaining device H. The reference sign 19 designates a catching device, e.g. a net, for preventing the stored energy source 4 that must be removed from falling.

The two tools 11, 12 can obviously also be replaced by a combined tool 10.

Both tools 11, 12 can also be replaced by e.g. a remotely controllable or autonomous flying drone which comprises an unlocking and pivoting device 14 of the first tool 11 and/or a grabber 18 of the second tool 12.

### LIST OF REFERENCE SIGNS

1 Housing
2 Mounting plate
3 Wireless module including stored energy source, structural unit
4 Battery, battery block, accumulator
5 Connection/contacting element, plug-in socket
6 Electronic device, wireless module, actuator, sensor
7 Interlocking mechanism
8 Detector socket
9 Electronic device, hazard detector, smoke detector, optical/acoustic alarm device
10 Tool, combined tool
11 First tool
12 Second tool
13 Rod, telescopic rod
14 Unlocking and pivoting device, stirrup
15 Peg, insertion peg
16 Peg, unlocking peg
17 Device, torque device, arm
18 Grabber, exchanger and tester
19 Catching device, net, transparent receptacle
20 Hinge, joint, pivoting joint
21 Main body
22 Closure part, housing cover, installation floor
23 Circuit board, printed circuit board
24 Activating means, pin, ridge, magnet
26 Sliding tray
27 Sliding plate
28 Front part
41 Battery contacts
51 Battery mating contacts
52 Connection element, socket connector
61 Connection contacts, pin connectors
71 Locking bar
72 Counterpart, fixed counterpart
90 Battery for wireless smoke detector
A Axis of symmetry of the housing or hazard detector
AB Connection base
AN Peg limit stop, limit stop
AR Receiving compartment
AS Outside of the closure part
BF Securing surface
BL Battery line
D Pivoting axis, rotational axis, pivot point
DK Activating element, push button
EO Unlocking aperture
F, F2 Spring element, cylinder spring
FG Wireless (IoT) hazard detector, smoke detector, motion detector, optical alarm device
FS Guide rails
G1, G2 First and second mating contacts, contact surfaces
GR Grip, handle
H Retaining device
H1 Retaining device part on the housing
H2 Retaining device part on the stored energy source
K1 First electrical contacts, contacting surfaces
K2 Second electrical contacts
KL Connection terminal
KO Electrical buffer store, capacitor, accumulator
L Detector line looped through
LO Length of the unlocking aperture, hole length
M Marking
MF Mounting surface, ceiling, wall
MK Detector head, electronic device
ML External line, detector line, detector bus
OF Inlet opening to the receiving compartment
OP Access opening
R1, R2 Directions away from and towards the mounting surface
SL Insertion aperture, blind hole
SR Blind hole for locking bar
SU Monitoring contact
TA Tangential limit stop
Z Centric widening
ZL Peg length

What is claimed is:

1. A housing comprising: which has
a shaped receiving compartment for receiving a stored energy source in the housing interior;
a connection option for supplying power to an electronic device connected to the stored energy source;
a main body; and
a closure part movably attached to the main body;
wherein the main body is configured to be removably mounted on a mounting surface;
when the main body is mounted on the mounting surface and said closure part is open, there is an access opening to the receiving compartment to allow removal of the stored energy source and insertion of a replacement stored energy source via the access opening;
the housing includes a retaining device for removably attaching the stored energy source to the retaining device; and
the retaining device is configured so the stored energy source can be removed from the retaining device in a direction away from the mounting surface and can be attached to the retaining device in a counter-direction towards the mounting surface.

2. The housing as claimed in claim 1, wherein:
the closure part is connected to the main body via a joint;
the closure part pivots about a pivoting axis of the joint;
the axis runs parallel to the mounting surface; and
pivoting the closure part exposes the access opening to the receiving compartment.

3. The housing as claimed in claim 1, wherein:
the closure part is connected to the main body via a joint so the closure part can be pivoted about a pivoting axis of the joint;
the axis runs perpendicular to the mounting surface; and
pivoting the closure part exposes the access opening to the receiving compartment.

4. The housing as claimed in claim 1, wherein:
the closure part comprises a sliding tray arranged in the main body and displacable parallel to the mounting surface;
the sliding tray comprises a sliding plate with a front part;
the front part closes the main body when the sliding tray is pushed in;
the front part exposes the access opening to the receiving compartment when the sliding tray is pulled out;
the sliding plate comprises the retaining device;
the retaining device allows the removable attachment of the stored energy source when the sliding tray is pulled out; and
the structural height of the sliding tray is dimensioned such that the replacement stored energy source which is attached to the sliding plate can be pushed into the main body of the housing.

5. The housing as claimed in claim 1, wherein:
a wireless module is permanently installed as an electronic device in the housing interior;
the wireless module is connected to the stored energy source via a connection/contacting element for the purpose of supplying power when the removably attachable stored energy source is installed; or
the electronic device comprises a wireless module and the wireless module together with the stored energy source form a structural unit for removably attaching to the retaining device as a connection option of the housing.

6. The housing as claimed in claim 2, wherein:
the main body at its end opposite the mounting surface forms a connection base as a connection option for supplying power to the electronic device and for removable attachment of the electronic device to the connection base; and
the connection base comprises an integral part of the main body or of the closure part movably attached to the main body.

7. The housing as claimed in claim 6, wherein the electronic device comprises at least one of: a hazard detector, an optical alarm device, an acoustic alarm device, or a motion detector.

8. The housing as claimed in claim 7, wherein:
the connection base comprises an activating means;
the activating means activates a monitoring contact of a hazard detector removably installed on the connection base only if said hazard detector is installed in a final position that is prescribed for correct operation of the hazard detector.

9. The housing as claimed in claim 6, wherein:
the housing comprises an electrical connection terminal for connection to an external line;
the connection base comprises first electrical contacts connected via a connection line arranged in the housing and flexible to the electrical connection terminal;
the first electrical contacts are so arranged as to contact with first electrical mating contacts of an electronic device installed on the connection base.

10. The housing as claimed in claim 7, wherein:
the connection base formed in the main body includes first electrical contacts arranged to contact with first electrical mating contacts of a hazard detector removably installed on the connection base;
the main body allows the housing to be removably mounted on a detector socket as a mounting surface;
the detector socket is configured to be secured to a ceiling and connected to a detector line and comprises second electrical contacts; and
the main body comprises second electrical mating contacts arranged as to contact with the second electrical contacts after the housing has been removably mounted on the detector socket.

11. The housing as claimed in claim 1,
wherein:
the closure part comprises a movable locking bar interacting mechanically with a fixed counterpart of the main body so the closure part interlocks with the main body when the receiving compartment is closed;
the main body comprises a movable locking bar interacting mechanically with a fixed counterpart of the closure part so the closure part interlocks with the main body when the receiving compartment is closed.

12. The housing as claimed in claim 11, wherein:
the closure part comprises an unlocking aperture on the outside so an unlocking tool geometrically compatible therewith can be inserted into the unlocking aperture to unlock the closure part and the interlocked main body for the purpose of reopening the receiving compartment.

13. The housing as claimed in claim 12, wherein:
the closure part is connected to the main body via a joint so the closure part pivots about a pivoting axis of the joint;
the pivoting axis runs perpendicular to the mounting surface to expose the access opening to the receiving compartment; and
the closure part comprises an insertion aperture including a pivot bearing aligned with the pivoting axis on the outside of said closure part so a pivoting open tool geometrically compatible therewith can be inserted into the insertion aperture.

14. The housing as claimed in claim 13, wherein:
the main body comprises a tangential limit stop against which the closure part rests in the closed state of the receiving compartment; and
the closure part automatically interlocks with the main body again when the tangential limit stop is reached.

15. A wireless hazard detector comprising:
a housing comprising:
a shaped receiving compartment for receiving a stored energy source in the housing interior;
a connection option for supplying power to an electronic device connected to the stored energy source;
a main body; and
a closure part movably attached to the main body;
wherein the main body is configured to be removably mounted on a mounting surface;
when the main body is mounted on the mounting surface and said closure part is open, there is an access opening to the receiving compartment to allow removal of the stored energy source and insertion of a replacement stored energy source via the access opening;
the housing includes a retaining device for removably attaching the stored energy source to the retaining device; and
the retaining device is configured so the stored energy source can be removed from the retaining device in a direction away from the mounting surface and can be attached to the retaining device in a counter-direction towards the mounting surface;
a wireless hazard detector;
wherein the main body of the housing is configured to be mounted on a mounting surface;
wherein the closure part is movably attached relative to the main body and comprises a floor element of a detector head of the wireless hazard detector;
the electronic device connected to the stored energy source for its power supply;
the detector head is connected via a battery line to a connection element in the main body so the detector head is electrically connected to the stored energy source for power after installation of the stored energy source in the receiving compartment of the main body.

16. The wireless hazard detector as claimed in claim 15, further comprising an electrical buffer store in the wireless hazard detector for electrical buffering of the power supply to the detector head during replacement of the stored energy source.

17. A first tool for unlocking, pivoting open and closing a housing as claimed in claim 12, the first tool comprising:
a rod;
an unlocking and pivoting device formed at a first rod end; and
a handle region formed at an opposite, second rod end;
wherein the unlocking and pivoting device includes a first and second end with first and second pegs formed thereon;
wherein the two pegs are disposed at a distance from each other so they can engage in both an unlocking aperture and an insertion aperture of the housing when installed on the mounting surface; and
a device between the first and second rod ends for applying torque to the rod when the housing is to be pivoted open or closed.

18. A second tool for removing a stored energy source from a retaining device and for inserting a replacement stored energy source via an access opening of a housing as claimed in claim 1, after the housing is installed on a mounting surface and in an open state, the second tool comprising:
a rod;
a grabber formed at a first rod end; and
a handle region formed at an opposite, second rod end;
wherein the grabber is configured to be selectively opened or closed.
